(19) United States
(12) Patent Application Publication
(10) Pub. No.: US 2026/0177945 A1
(43) Pub. Date: Jun. 25, 2026

(54) IMAGE FORMING APPARATUS

(71) Applicant: KYOCERA Document Solutions Inc., Osaka (JP)

(72) Inventor: Takeshi YOSHIDA, Osaka (JP)

(73) Assignee: KYOCERA Document Solutions Inc., Osaka (JP)

(21) Appl. No.: 19/418,857

(22) Filed: Dec. 12, 2025

(30) Foreign Application Priority Data
Dec. 20, 2024 (JP) 2024-225024
Dec. 20, 2024 (JP) 2024-225025

(51) Int. Cl. G03G 15/08; G03G 15/01; G03G 21/16

(52) U.S. Cl. CPC G03G 15/0813; G03G 15/0121; G03G 21/1647; G03G 2221/163

(57) ABSTRACT

An image forming apparatus includes a separation device and a plurality of developing devices including a developing device for monochrome image and a developing device for color image. The separation device is configured to switch a state of the image forming apparatus to any one state of: an insertable/removable state where all of the plurality of developing devices are arranged at the separation position; a normal printing state where all of the plurality of developing devices are arranged at the developing position; and a monochrome printing state where the developing device for monochrome image is arranged at the developing position and the developing device for color image is arranged at the separation position.

### INCORPORATION BY REFERENCE

This application is based on and claims the benefit of priority from Japanese patent applications No. 2024-225024 and No. 2024-225025, filed on Dec. 20, 2024, which are incorporated by reference in its entirety.

### BACKGROUND

The present disclosure relates to an image forming apparatus.

The electrophotographic image forming apparatus includes a developing device including a developer carrier which develops an electrostatic latent image by coming close to or into contact with an image carrier while rotating, a moving mechanism which rocks the developing device, and a drive input gear which inputs a driving force to the developer carrier through a drive transmission gear. The developing device is provided so as to be rockable between a developing position where the developer carrier is close to or in contact with the image carrier and a separation position where the developer carrier is separated from the image carrier. The rocking fulcrum of the developing device is provided on the opposite side to the drive input gear across the drive transmission gear. In a state where the developing device is in the developing position, the center axis of the drive transmission gear is located on the downstream of a straight line connecting the rocking fulcrum and the center axis of the drive input gear in the rocking direction to the separation position, and the developing device is allowed to be rocked from the developing position to the separation position. In the image forming apparatus, the developing device is rocked to the separation position during a period when the image forming operation (printing) is stopped, so that the developer carrier is separated from the image carrier and the drive transmission gear is separated from the drive input gear. This suppresses deterioration of the developer in the developing device.

The developer carrier, the developing device, the drive transmission gear and the drive input gear are each provided in four units. The moving mechanism includes a drive mechanism for reciprocating a link member for pressing the developing device. The driving mechanism switches the state of the image forming apparatus to any one of a first state in which a monochrome developing device is arranged at the developing position and other developing devices are arranged at the separation position, a second state in which all the developing devices are arranged at the separation position, and a third state in which all the developing devices are arranged at the developing position.

### SUMMARY

The first embodiment of an image forming apparatus according to the present disclosure includes an image carrier, a developing device, a separation device and a drive input member. The image carrier is attached to an apparatus main body so as to be movable in an axial direction and is configured to carry an electrostatic latent image while rotating around an axis. The developing device includes a developing member which is configured to rotate around an axis while being close to or in contact with the image carrier to develop the electrostatic latent image, is attached to the apparatus main body so as to be movable in the axial direction, and is configured to be turned around a rocking shaft arranged in parallel with the developing member. The separation device is configured to turn the developing device between a developing position where the developing member is brought close to or into contact with the image carrier and a separation position where the developing member is separated from the image carrier. The drive input member is supported by the separation device so as to be rotatable around an axis, and is configured to input a driving force to the developing member. The image carrier includes a plurality of image carriers including an image carrier for monochrome image and an image carrier for color image and arranged in a separation direction orthogonal to the axial direction. The developing device includes a plurality of developing devices including a developing device for monochrome image and a developing device for color image and arranged in the separation direction. The drive input member includes a plurality of drive input members including a drive input member for monochrome image and a drive input member for color image and is arranged in the separation direction. The image carrier and the developing device are configured to be pulled out from the apparatus main body in one direction of the axial direction in a state where the developing device is arranged at the separation position. The developing member is disposed offset from the drive input member in the one direction in the axial direction and is configured to be coupled to one end portion of the drive input member in the axial direction. The separation device is configured to separate the developing member from the drive input member in the axial direction and then turn the developing device from the developing position to the separation position and turn the developing device from the separation position to the developing position and then couple the developing member to the drive input member in the axial direction. The separation device is configured to switch a state of the image forming apparatus to any one state of: an insertable/removable state where all of the plurality of developing devices are arranged at the separation position; a normal printing state where all of the plurality of developing devices are arranged at the developing position; and a monochrome printing state where the developing device for monochrome image is arranged at the developing position and the developing device for color image is arranged at the separation position.

The second embodiment of an image forming apparatus according to the present disclosure includes a developing device for monochrome image, a developing device for color image, a color slider, a slide drive part, a monochrome slider and a link mechanism. The developing device for monochrome image is configured to come close to or come into contact with an image carrier for monochrome image in one direction of a predetermined separation direction and develop an electrostatic latent image carried by the image carrier for monochrome image. The developing device for color image is configured to come close to or come into contact with an image carrier for color image in the one direction of the separation direction and develop an electrostatic latent image carried by the image carrier for color image. The color slider has a projection portion configured to come into contact with the developing device for color image. The slide drive part is configured to move the color slider in the one direction of the separation direction in order to set a state of the image forming apparatus to a monochrome printing state, thereby causing the projection portion of the color slider to come into contact with the developing device for color image, and
causing the projection portion to move the developing device for color image in the one direction of the separation direction and to separate the developing device for color image from the image carrier for color image. The monochrome printing state is a state where the developing device for monochrome image is closer to or in contact with the image carrier for monochrome image and the developing device for color image is separated from the image carrier for color image. The monochrome slider has an abutting step portion configured to abut on the color slider and a projection portion configured to come into contact with the developing device for monochrome image. The link mechanism is engaged with the monochrome slider and coupled to a manual lever and configured to move the monochrome slider in the one direction of the separation direction as the manual lever is turned, in order to set the state of the image forming apparatus to an insertable/removable state, thereby causing the projection portion of the monochrome slider to come into contact with the developing device for monochrome image and to separate the developing device for monochrome image from the image carrier for monochrome image in the one direction of the separation direction, and causing the abutting step portion of the monochrome slider to abut on the color slider and to move the color slider in the one direction of the separation direction, thereby separating the developing device for color image from the image carrier for color image. The insertable/removable state is a state where the developing device for monochrome image is separated from the image carrier for monochrome image and the developing device for color image is separated from the image carrier for color image.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a perspective view showing an image forming apparatus according to one embodiment of the present disclosure.

FIG. 2 is a schematic (side) view showing an internal structure of the image forming apparatus according to the embodiment of the present disclosure.

FIG. 3 is a perspective view showing a photosensitive drum, a developing device, and a separation device and the like, of the image forming apparatus according to the embodiment of the present disclosure.

FIG. 4 is a plan view showing the separation device (in an initial state and a normal printing state) of the image forming apparatus according to the embodiment of the present disclosure.

FIG. 5 is a cross-sectional view taken along the line V-V of FIG. 4.

FIG. 6 is a right side view showing the photosensitive drum, the developing device (at a developing position), and the separation device of the image forming apparatus according to the embodiment of the present disclosure.

FIG. 7 is an exploded perspective view showing a rotation transmission device and the separation device of the image forming apparatus according to the embodiment of the present disclosure.

FIG. 8 is a left side view for explaining the rotation transmission device in a state where a driving force can be transmitted to a developing roller, in the image forming apparatus according to the embodiment of the present disclosure.

FIG. 9 is a cross-sectional view taken along the line I-I of FIG. 8.

FIG. 10 is a left side view for explaining the rotation transmission device in a state where the driving force cannot be transmitted to the developing roller, in the image forming apparatus according to the embodiment of the present disclosure.

FIG. 11 is a cross-sectional view taken along the line II-II of FIG. 10.

FIG. 12 is an exploded perspective view showing the separation device of the image forming apparatus according to the embodiment of the present disclosure.

FIG. 13 is a plan view showing the separation device (at an insertable/removable state) of the image forming apparatus according to the embodiment of the present disclosure.

FIG. 14 is a cross-sectional view taken along the line XII-XII of FIG. 13.

FIG. 15 is a right side view showing the photosensitive drum, the developing device (at a separation position), and the separation device of the image forming apparatus according to the embodiment of the present disclosure.

FIG. 16 is a plan view showing the separation device (at a monochrome printing state) of the image forming apparatus according to the embodiment of the present disclosure.

FIG. 17 is a cross-sectional view taken along the line XV-XV of FIG. 16.

### DETAILED DESCRIPTION

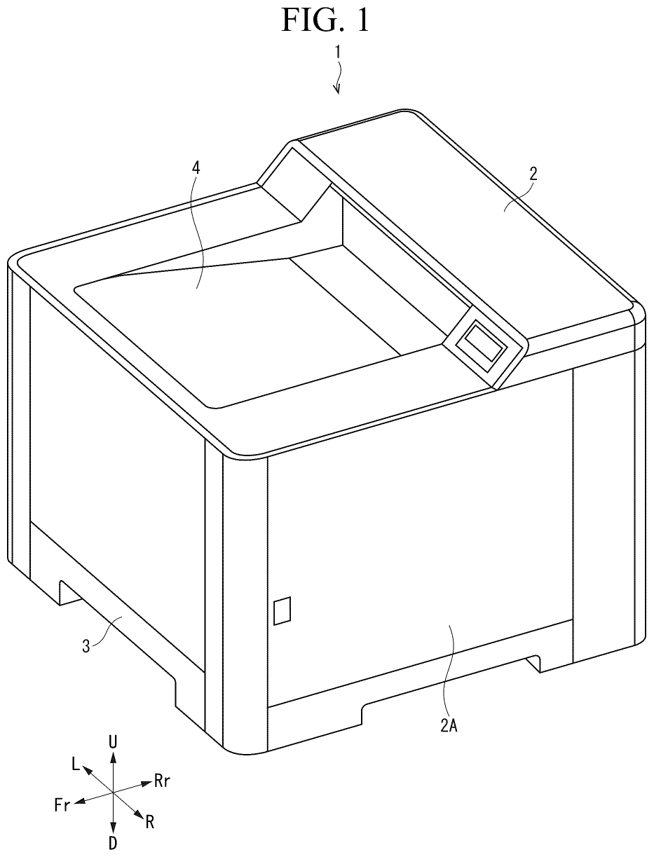

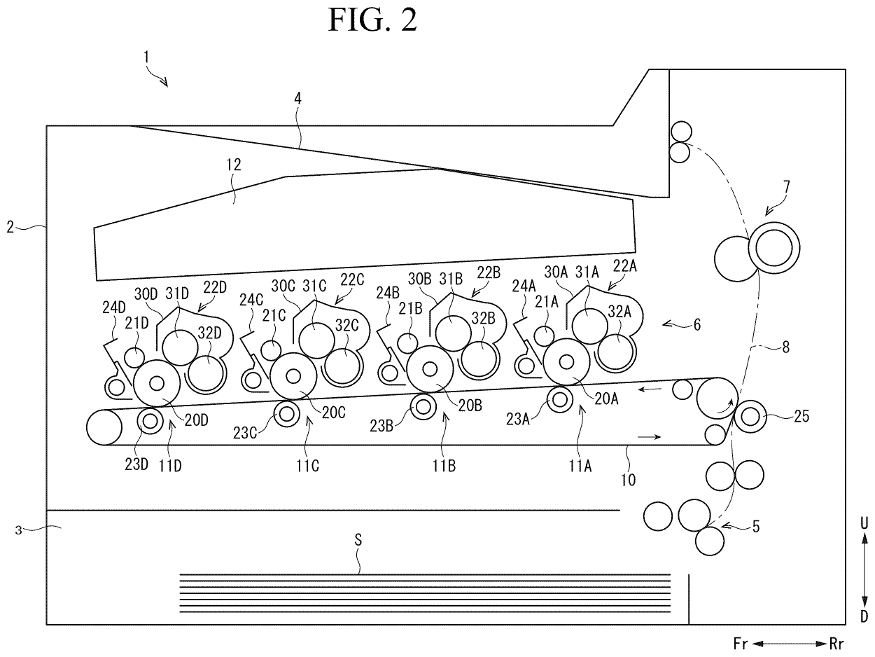

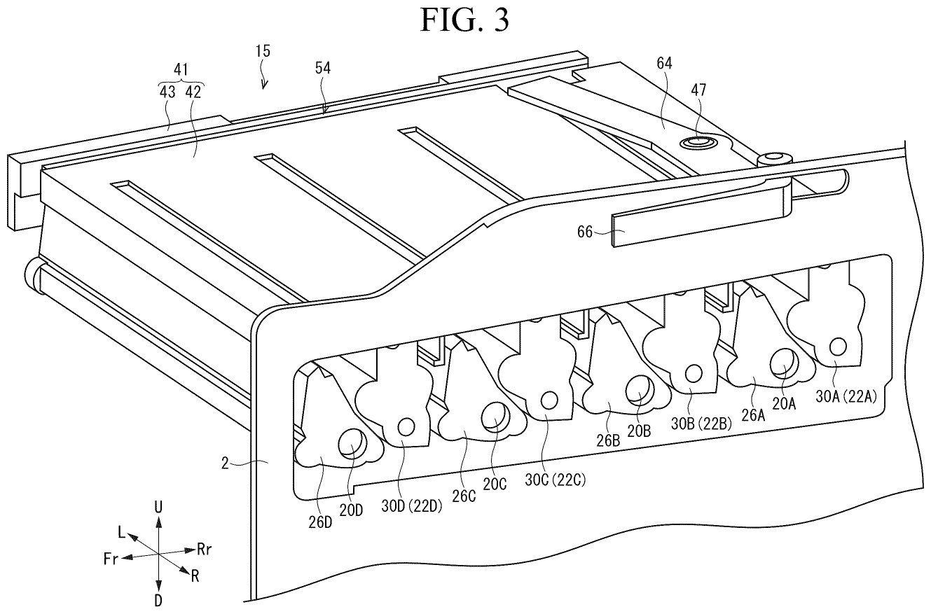

Hereinafter, with reference to the accompanying drawings, an embodiment of the present disclosure will be described. Fr, Rr, L, R, U, and D in the drawings indicate the front, rear, left, right, upper, and down, respectively. The front-and-rear direction (the separation direction), the left-and-right direction (the axial direction), and the upper-and-down direction are orthogonal to each other. Although the directional and positional terms are used in the specification, they are for convenience of description and are not intended to limit the scope of the disclosure. In the drawings, the shapes, dimensions, angles, and the like of the respective components are not accurate but are schematized for the purpose of explanation.

[Image Forming Apparatus] With reference to FIG. 1 to FIG. 3, an image forming apparatus 1 according to the present embodiment will be described. FIG. 1 is a perspective view showing the image forming apparatus 1. FIG. 2 is a schematic view (a side view) showing the image forming apparatus 1. FIG. 3 is a perspective view showing a photosensitive drum 20, a developing device 22, and a separation device 15 and the like.

The image forming apparatus 1 is a printer for forming an image on a sheet S (a medium) by an electrophotographic method. As shown in FIG. 1 and FIG. 2, the image forming apparatus 1 includes an apparatus main body 2 constituting a substantially rectangular parallelepiped appearance. A sheet feeding cassette 3 in which the sheet S is stored is detachably attached in the lower portion of the apparatus main body 2. On the upper surface of the apparatus main body 2, a discharge tray 4 is provided and the image-formed sheet S is received on the discharge tray 4. The apparatus main body 2 has frames constituting the skeleton of the image forming apparatus 1 and exterior members attached to the frames to constitute the exterior of the image forming apparatus 1. The sheet S is not limited to a paper sheet but may be made of a resin sheet or the like. Further, in the specification, the terms “upstream” and “downstream”, and the similar expressions refer to “an upstream” and “a downstream”, and the similar concepts in the conveying direction of the sheet S.

As shown in FIG. 2, a conveying path 8 along which the sheet S is conveyed from the sheet feeding cassette 3 to the sheet discharge tray 4 is provided inside the apparatus main body 2. A sheet feeding device 5 is provided at the upstream end of the conveying path 8, an image forming device 6 is provided at the midstream portion of the conveying path 8, and a fixing device 7 is provided at the downstream side portion of the conveying path 8.

The image forming device 6 includes an intermediate transfer belt 10, four image forming parts 11A to 11D, and an exposure device 12. The intermediate transfer belt 10 is wound around a plurality of rollers provided above the sheet feeding cassette 3. One roller connected to a belt drive motor (not shown) is rotationally driven to travel the intermediate transfer belt 10 in the counterclockwise direction in FIG. 2. The four image forming parts 11A to 11D are arranged side by side in the front-and-rear direction (the separation direction) above the intermediate transfer belt 10. As an example, the four image forming parts 11A to 11D form yellow, magenta, cyan, and black images in the order from the rear to the front in FIG. 2. The exposure device 12 is provided above the four image forming parts 11A to 11D.

Since the four image forming parts 11A to 11D have substantially the same structure, in the description common to the four image forming parts 11A to 11D in the specification, attention may sometimes be paid to any one image forming part 11, and only arithmetic numerals may be attached to the symbols. Also, “A, B, C, and D” may be attached to the symbols of the components included in the image forming parts 11A to 11D and the symbols of the components provided corresponding to the image forming parts 11A to 11D. Also, in the present specification, attention may mainly be paid to one of these components, and sometimes only arithmetic numerals are attached to the symbols.

The image forming parts 11A to 11D include photosensitive drums 20A to 20D, charging devices 21A to 21D, developing devices 22A to 22D, primary transfer rollers 23A to 23D, and cleaning devices 24A to 24D. The photosensitive drum 20D, the charging device 21D, the developing device 22D, the primary transfer roller 23D and the cleaning device 24D are included in the monochrome image forming part corresponding to black toner. The photosensitive drums 20A to 20C, the charging devices 21A to 21C, the developing devices 22A to 22C, the primary transfer rollers 23A to 23C, and the cleaning devices 24A to 24C are included in the color image forming parts corresponding to color toners other than the black toner.

The photosensitive drum 20 as an example of the image carrier is formed in a cylindrical shape extending in the left-and-right direction and is housed and unitized in a photosensitive drum housing 26 (26A to 26D) (see FIG. 3). The photosensitive drum 20 is supported by the photosensitive drum housing 26 so as to be rotatable around an axis. The photosensitive drum 20 is rotationally driven by a drive motor (not shown) connected via a power transmission mechanism (not shown) such as a gear train, while being in contact with the intermediate transfer belt 10. The charging device 21, the developing device 22, the primary transfer roller 23, and the cleaning device 24 are arranged around the photosensitive drum 20 in the order of the image forming process. The primary transfer roller 23 faces the photosensitive drum 20 across the intermediate transfer belt 10. A secondary transfer roller 25 is in contact with the rear side portion of the intermediate transfer belt 10.

The developing device 22 is disposed behind the photosensitive drum 20, for example. The developing devices 22A to 22D include developing housings 30A to 30D, developing rollers 31A to 31D, and supply rollers 32A to 32D. The developing housing 30 is connected to a toner container (not shown) via a replenishment path (not shown) and is formed to be capable of storing the toner (developer) replenished from the toner container. As an example, the four developing housings 30A to 30D are filled with the yellow, magenta, cyan, and black toners in the order from the rear to the front in FIG. 2. The developing roller 31 and the supply roller 32 are disposed in the developing housing 30 and are supported by the developing housing 30 so as to be rotatable around axes. The developing roller 31 as an example of the developing member is disposed so as to be close to the photosensitive drum 20 from the rear side (more specifically, the rear oblique upper side (one direction in the separation direction)). Specifically, regulation rollers (not shown) provided at both axial end portions of the developing roller 31 abut on the peripheral surface of the photosensitive drum 20, so that the peripheral surface of the photosensitive drum 20 and the peripheral surface of the developing roller 31 are disposed close to each other through a predetermined gap. The supply roller 32 is disposed below the developing roller 31 and supplies the toner in the developing housing 30 to the outer peripheral surface of the developing roller 31. Although the developing roller is close to the photosensitive drum 20, the present disclosure is not limited to this, and the developing roller 31 may rotate around the axis while being in contact with the photosensitive drum 20.

As will be described later in detail, the developing roller 31 and the supply roller 32 are connected to a drive motor via a drive input gear 36, a drive coupling 38, and the others. The developing roller 31 is applied with a driving force from the drive motor and is rotationally driven. The supply roller 32 is rotationally driven interlocked with the developing roller 31.

[Image Forming Process] The image forming apparatus 1 forms an image on the sheet S based on image data transmitted from, for example, an external terminal (such as a personal computer and the like). A control part (not shown) provided in the image forming apparatus 1 controls the image forming apparatus 1 based on the input image data, and the image forming process is executed as follows.

The charging device 21 charges the surface of the photosensitive drum 20. The exposure device 12 exposes the photosensitive drum 20 based on the image data and forms an electrostatic latent image on the surface of the photosensitive drum 20. The photosensitive drum 20 carries the electrostatic latent image while rotating around the axis. The developing roller 31 of the developing device 22 rotates around the axis while being close to the photosensitive drum 20, supplies the toner to the photosensitive drum 20, and develops the electrostatic latent image on the photosensitive drum 20 into a toner image. The toner images of four colors carried on the four photosensitive drums 20A to 20D are sequentially primarily transferred to the intermediate transfer belt 10 by the primary transfer rollers 23A to 23D to which a primary transfer bias is applied. Thus, a full-color toner image is formed on the surface of the intermediate transfer belt 10.

The sheet S is fed from the sheet feeding cassette 3 to the conveying path 8 by the sheet feeding device 5, and the toner image carried on the intermediate transfer belt 10 is secondarily transferred to the sheet S by the secondary transfer roller 25 to which a secondary transfer bias is applied. The toner image is thermally fixed to the sheet S by the fixing device 7, and then the sheet S is discharged to the discharge tray 4. The toner remaining on the surface of the photosensitive drum 20 is removed by the cleaning device 24, and the charge on the photosensitive drum 20 is removed by a static eliminator (not shown).

In the image forming apparatus 1, for example, for maintenance and replacement of the photosensitive drum 20 and the developing device 22, the photosensitive drum 20 and the developing device 22 are attached to the apparatus main body 2 so as to be movable in the left-and-right direction (the axial direction). As an example, a cover 2A (see FIG. 1) is provided on the right side surface of the apparatus main body 2 to be openable and closable. By opening the cover 2A, the right side of the image forming device 6 including the developing device 22 and the others is exposed (see FIG. 3), and the attaching/detaching operation of the developing device 22 and the others becomes possible. The cover 2A is rotatably provided around, for example, upper and lower hinges (not shown) spaced apart in the up-and-down direction provided at the rear portion. Further, since the photosensitive drum 20 is housed and unitized in the photosensitive drum housing 26, the unitized photosensitive drum 20 is attached to and detached from the apparatus main body 2.

When the photosensitive drum 20 or the developing device 22 is attached to or detached from the apparatus main body 2 in a state where the developing roller 31 is close to the photosensitive drum 20, the developing roller 31 and the photosensitive drum 20 may come into contact with each other and be damaged. Therefore, when the photosensitive drum 20 and the like are attached to and detached from the apparatus main body 2, it is necessary to separate the developing roller 31 from the photosensitive drum 20. Further, before the developing roller 31 (the developing device 22) is separated from the photosensitive drum 20, it is necessary to release the coupling between the developing roller 31 and the drive motor.

When a monochrome image is formed, the color image developing rollers 31 are preferably separated from the photosensitive drums 20 in order to suppress deterioration of the color image developing rollers 31 and the photosensitive drums 20. Further, when the monochrome image is formed, it is preferable to release the coupling between the color image developing roller 31 and the drive motor in order to suppress deterioration of the toner due to continuous agitation of the toner in the developing housing 30 of the color image developing device 22.

Therefore, the image forming apparatus 1 according to the present embodiment is provided with a separation device 15 which separates the developing roller 31 from the photosensitive drum 20 and releases the coupling between the developing device 22 and the drive motor when the developing device 22 is attached to and detached from the apparatus main body 2.

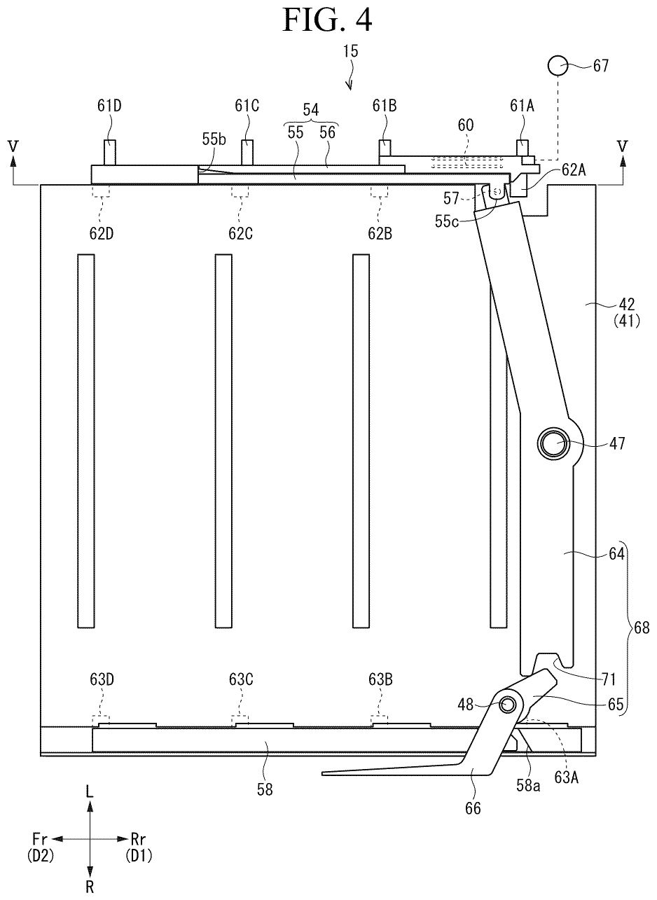

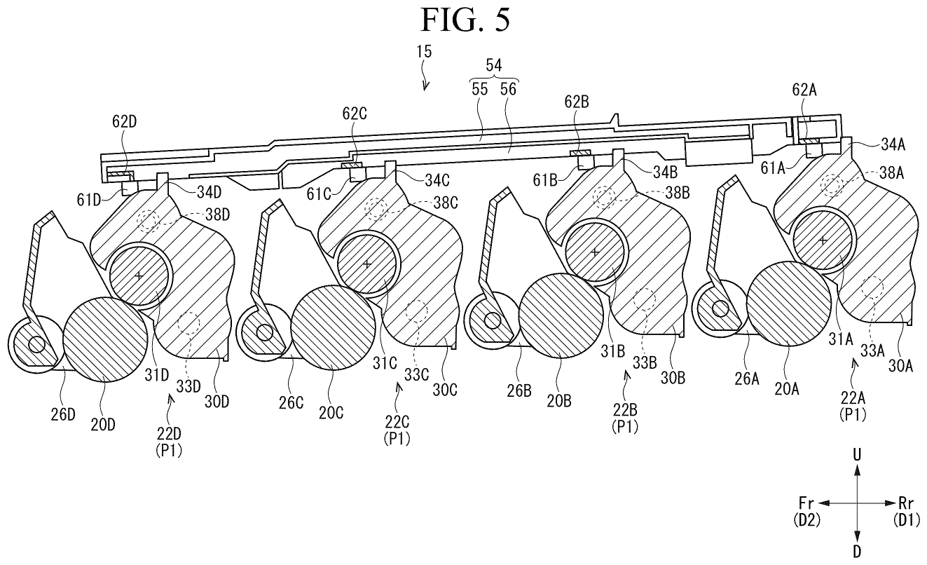

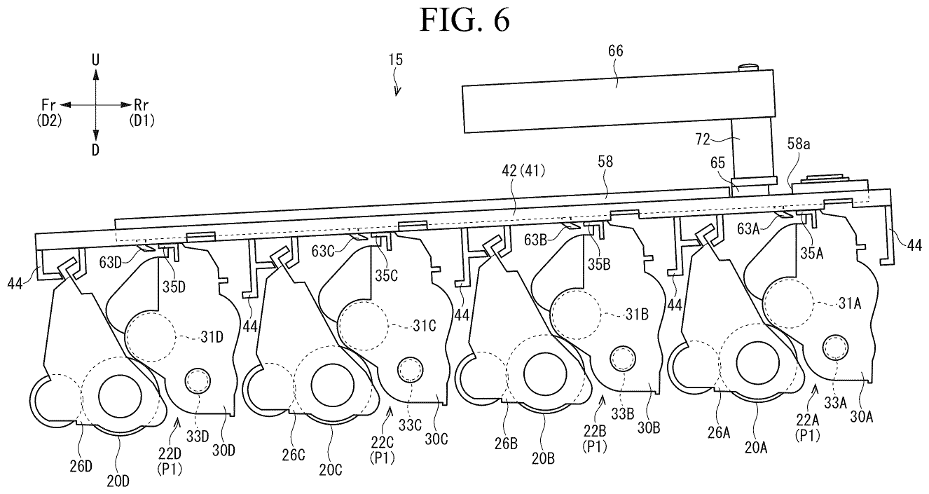

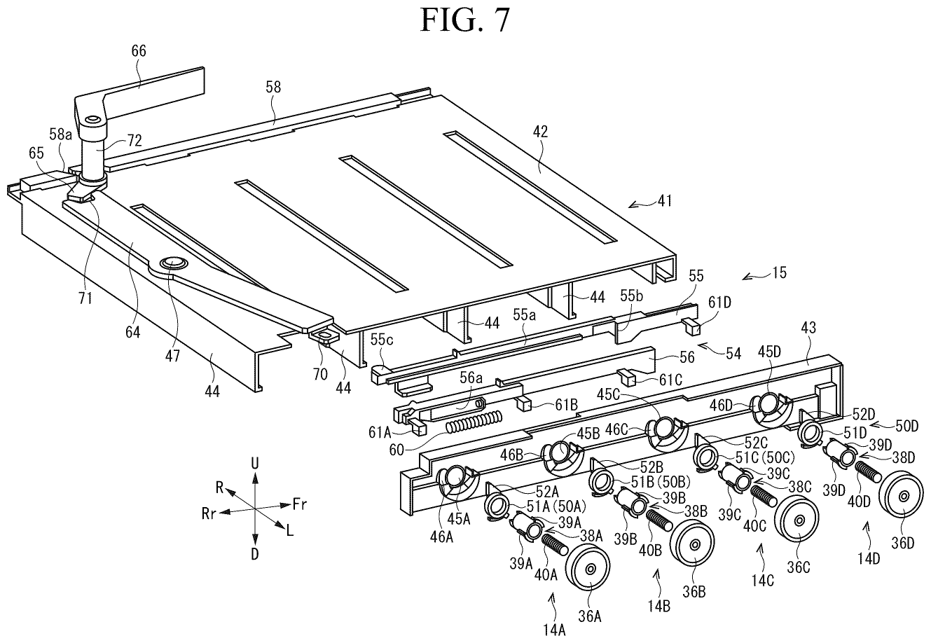

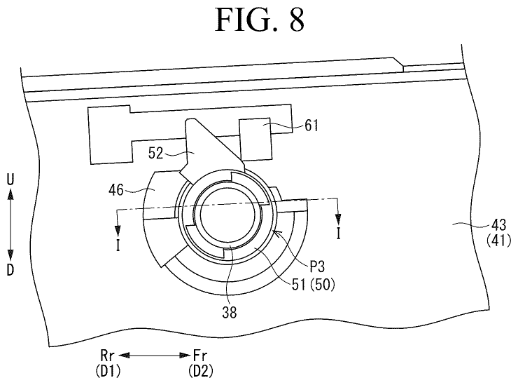

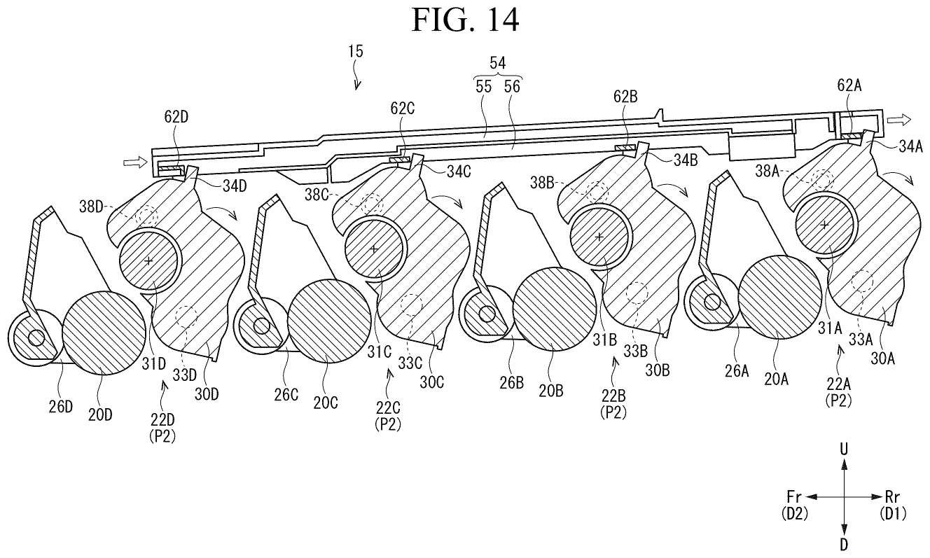

Prior to the description of the separation device 15, with reference to FIG. 4 to FIG. 11, rotation transmission devices 14A to 14D which transmit the driving force (the rotational force) to the developing devices 22A to 22D and the developing rollers 31A to 31D will be further described. FIG. 4 is a plan view showing the separation device 15. FIG. 5 is a cross-sectional view taken along the line V-V of FIG. 4. FIG. 6 is a right side view showing the photosensitive drum 20, the developing device 22, and the separation device 15. FIG. 7 is an exploded perspective view showing the rotation transmission device 14 and the separation device 15. FIG. 8 to 11 are explanatory views (the left side view and the cross-sectional view) for explaining the rotation transmission device 14.

[Developing Device] The developing device 22 is supported by the apparatus main body 2 so as to be rockable in the front-and-rear direction. Specifically, as shown in FIG. 5, the developing device 22 is turned around rocking shafts 33 (33A to 33D) arranged in parallel with the developing roller 31 and radially offset from the developing roller 31. The rocking shafts 33 are provided on both left side and right side of the developing housing 30. The rocking shafts 33 are provided at a position away downward (in detail, diagonally downward and rearward) from the rotation center (see the cross mark in FIG. 5) of the developing roller 31 when the developing housing 30 is viewed from the side surface. The developing device 22 is turned between a developing position P1 (see FIG. 5 and FIG. 6) where the developing roller 31 is brought close to the photosensitive drum 20 and a separation position P2 (see FIG. 14, described later) where the developing roller 31 is separated rearward from the photosensitive drum 20. The photosensitive drum 20 and the developing device 22 can be pulled out from the apparatus main body 2 rightward (one direction in the axial direction) in a state where the developing device 22 is arranged at the separation position P2. Although not shown, the developing housing 30 is provided with a return member (not shown) which biases the developing device 22 from the separation position P2 toward the developing position P1.

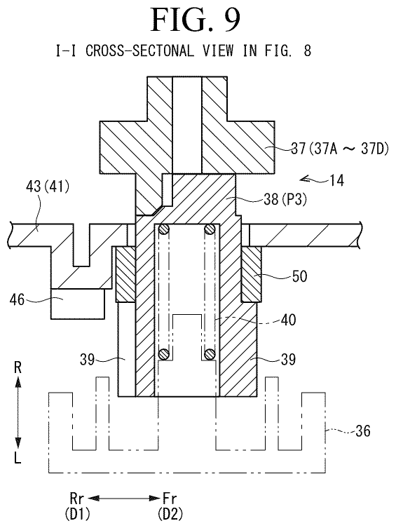

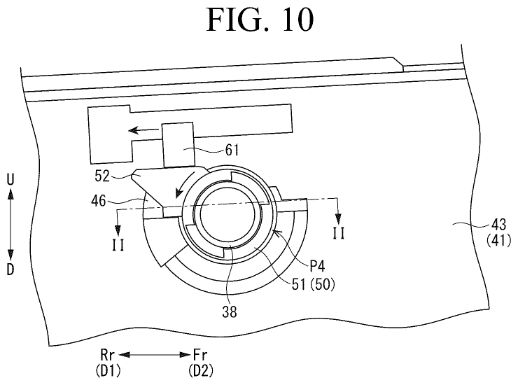

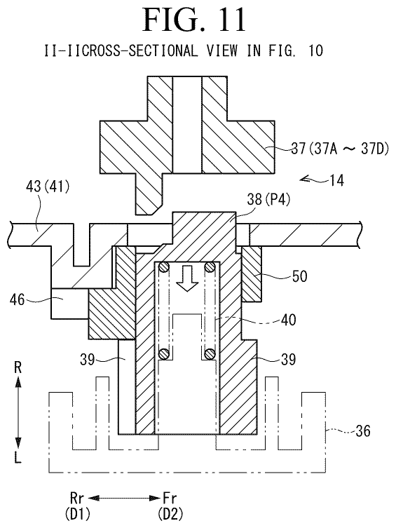

As shown in FIG. 5, first engagement portions 34A to 34D are provided at the upper portions of the left end portions of the developing housings 30A to 30D. The first engagement portion 34 is formed into a projection projecting upward from the upper portion of the left end portion of the developing housing 30. As shown in FIG. 6, second engagement portions 35A to 35D are provided at the upper portions of the developing housings 30A to 30D over substantially the entire area in the left-and-right direction. The second engagement portion 35 is formed in a substantially L-shaped rail shape protruding upward from the upper portion of the developing housing 30 and bending forward when the second engagement portion 35 is viewed from the side surface.

[Rotation Transmission Device] As shown in FIG. 7, the rotation transmission devices 14A to 14D are provided on the left side (the other side in the axial direction) of the developing devices 22A to 22D. The rotation transmission devices 14A to 14D include drive input gears 36A to 36D, drive transmission gears 37A to 37D (see FIG. 8 to FIG. 11), and drive couplings 38A to 38D. The drive input gear 36D, the drive transmission gear 37D and the drive coupling 38D are the members for monochrome image forming. The drive input gears 36A to 36C, the drive transmission gears 37A to 37C, and the drive couplings 38A to 38C are the members for color image forming. The drive input gear 36, the drive transmission gear 37 and the drive coupling 38 are arranged in a row in the left-and-right direction (the axial direction).

<Drive Input Gear, Drive Transmission Gear> The drive input gear 36 (the drive input member) is, for example, a spur gear and is supported by the later-described separation device 15 so as to be rotatable around an axis. The drive input gear 36 is connected to the drive motor via a gear train (not shown) or the like. The drive transmission gear 37 is, for example, a spur gear and is supported by the developing housing 30 so as to be rotatable around an axis. The drive transmission gear 37 is connected to the developing roller 31 and the supply roller 32 via an intermediate gear (not shown) or the like.

<Drive Coupling> As shown in FIG. 7 to FIG. 9, the drive coupling 38 is formed in a substantially cylindrical shape with the right end surface closed. A pair of drive ribs 39 (39A to 39D) projects radially outward from the outer peripheral surface of the drive coupling 38. One of the pair of drive ribs 39 is provided at a position linearly symmetrical to the other of the pair of drive ribs with respect to the axis of the drive coupling 38. The drive coupling 38 is provided to be movable between the drive input gear 36 and the drive transmission gear 37 in the left-and-right direction (the axial direction). The drive coupling 38 moves between a coupling position P3 (see FIG. 8 and FIG. 9) where the drive coupling 38 couples the drive input gear 36 to the drive transmission gear 37 and a separation position P4 (see FIG. 10 and FIG. 11) where the drive coupling 38 comes close to the drive input gear 36 and separates from the drive transmission gear 37.

A biasing coupling member 40 (40A to 40D) (for example, a compression coil spring) is accommodated in the axial center portion of the drive coupling 38. The biasing coupling member 40 is provided between the drive input gear 36 and the drive coupling 38 and biases the drive coupling 38 toward the drive transmission gear 37. That is, the drive coupling 38 is pushed toward the coupling position P3 by the biasing coupling member 40 (see FIG. 9).

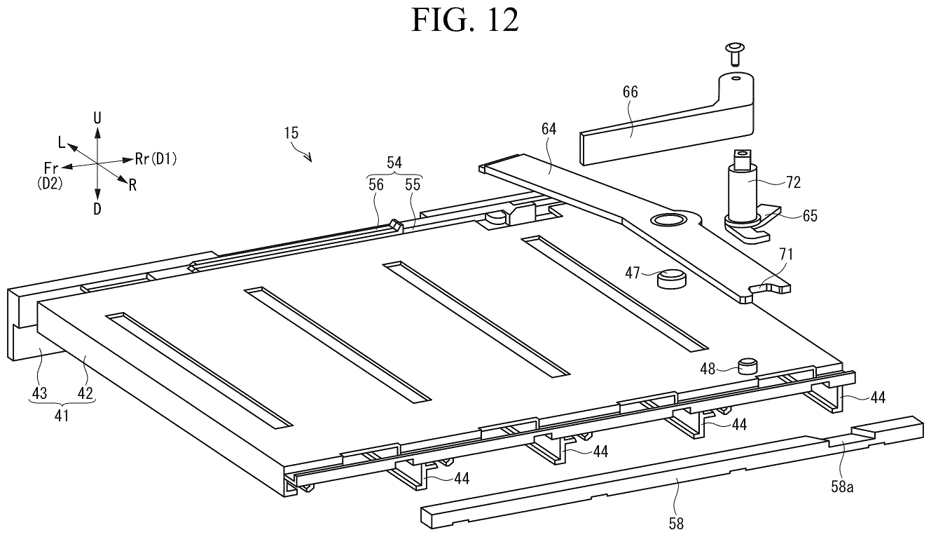

The developing roller 31 is disposed rightward (one direction in the axial direction) and is offset from the drive input gear 36. When the drive coupling 38 is arranged at the coupling position P3, the developing roller 31 is coupled to the right surface (one end portion in the axial direction) of the drive input gear 36 via the drive transmission gear 37 and the drive coupling 38. Thus, the state of the drive input gear 36 is a state where the driving force can be input to the developing roller 31 and the supply roller 32 through the drive transmission gear 37 and the drive coupling 38.

[Separation Device] Next, with reference to FIG. 4 to FIG. 12, the separation device 15 will be described. FIG. 12 is an exploded perspective view showing the separation device 15.

The separation device 15 has a function of turning the developing device 22 between the developing position P1 and the separation position P2 and a function of switching the coupling state of the developing roller 31 and the drive input gear 36. As shown in FIG. 7, the separation device 15 includes a support member 41, release arms 50A to 50D, a first slider 54, a second slider 58, a first link 64, a second link 65, a manual lever 66, and a slide drive part 67 (see FIG. 4).

<Support Member> As shown in FIG. 7, the support member 41 has a support body 42 and a mounting guide 43. The support body 42 is formed in a flat plate shape to cover the area above the four developing devices 22A to 22D (see FIG. 6). On the lower surface of the support body 42, rail portions 44 are provided so as to hang down and support the unitized photosensitive drums 20 and the developing devices 22 slidably in the left-and-right direction (the axial direction) (see FIG. 6).

The mounting guide 43 is mounted to the left end portion (the other end portion in the axial direction) of the support body 42 with a gap in which the first slider 54 described later can be disposed (see FIG. 12). The mounting guide 43 has shaft holes 45A to 45D at equal intervals in the front-and-rear direction (the separation direction). The shaft hole 45 is a circular opening, and the drive coupling 38 is inserted into the shaft hole 45. The mounting guide 43 (the support member 41) supports the drive couplings 38 so as to be rotatable and movable in the left-and-right direction (the axial direction). On the left surface of the mounting guide 43, inclined surface portions 46A to 46D are formed along the rear edge portions of the shaft holes 45A to 45D. The inclined surface portion 46 has a surface inclined toward the left (the other side in the axial direction) from the upper to the lower.

<Release Arm> As shown in FIG. 7, the release arms 50A to 50D are provided on the left side (the other side in the axial direction) of the support member 41. As shown in FIG. 7 and FIG. 8, the release arm 50 has an annular portion 51 (51A to 51D) and an arm portion 52 (52A to 52D).

The annular portion 51 is formed in an annular shape, and the drive coupling 38 is inserted into the annular portion 51. Thus, the release arm 50 is rotatably provided along the outer peripheral surface of the drive coupling 38. The arm portion 52 extends radially outward from the outer peripheral surface of the annular portion 51. The arm portion 52 is formed to be in contact with the inclined surface portion 46 formed on the mounting guide 43 (the support member 41). The release arm 50 is moved in the left-and-right direction (the axial direction) by turning while bringing the arm portion 52 into contact with the inclined surface portion 46.

As shown in FIG. 10, when the release arm 50 is moved leftward while turning in the counterclockwise direction, as shown in FIG. 11, the distal end (the left end) of the annular portion 51 abuts on the drive rib 39 to move the drive coupling 38 leftward against the biasing force of the biasing coupling member 40. Thereby, the drive coupling 38 is separated from the drive transmission gear 37 so that transmission of the driving force to the developing roller 31 is interrupted.

<First Slider> As shown in FIG. 4 and FIG. 7, the first slider 54 is provided on the left side (the other side in the axial direction) of the support member 41. Specifically, the first slider 54 is disposed between the support body 42 and the mounting guide 43 (see also FIG. 12). The first slider 54 has a monochrome slider 55 corresponding to the monochrome image developing device 22D and a color slider 56 corresponding to the color image developing devices 22A to 22C. The monochrome slider 55 and the color slider 56 are each formed into a long and thin rod elongated in the front-and-rear direction. In the present specification, for convenience of explanation, the rear direction (one direction of the separation direction) is referred to as “an engagement direction D1” and the front direction (the other direction of the separation direction) is referred to as “a disengagement direction D2”. Therefore, the first slider 54 is movable in the engagement direction D1 and in the disengagement direction D2.

(Monochrome Slider) The monochrome slider 55 is supported by the mounting guide 43 so as to be movable in the front-and-rear direction (the separation direction). As shown in FIG. 7, a slider housing portion 55a capable of housing the color slider 56 is formed in the monochrome slider 55 excluding the front side portion. The slider housing portion 55a is formed in such a manner that the left side portion of the monochrome slider 55 is largely cut off, and an abutting step portion 55b is formed at the front end of the slider housing portion 55a. A first joint shaft portion 57 (see FIG. 4) is formed at the rear end portion of the monochrome slider 55 via a bracket 55c projecting rightward. The first joint shaft portion 57 projects downward from the lower surface of the bracket 55c.

As shown in FIG. 4, FIG. 5, and FIG. 7, the monochrome slider 55 has a first projection portion 61D which is provided so as to be contactable with the monochrome image release arm 50D, and a second projection portion 62D which is provided so as to be contactable with (the left end of) the monochrome image developing device 22D. The first projection portion 61D projects leftward from the lower portion of the left side surface of the monochrome slider 55 on the front side of the monochrome slider 55 excluding the slider housing portion 55a. The second projection 62D projects rightward from the lower portion of the right side surface of the monochrome slider 55 on the front side of the monochrome slider 55. The second projection portion 62D is provided forward (in the disengagement direction D2) and is offset from the first projection portion 61D.

(Color Slider) As shown in FIG. 4, FIG. 5 and FIG. 7, the color slider 56 is supported by the slider housing portion 55a of the monochrome slider 55 so as to be movable in the front-and-rear direction. A biasing housing portion 56a (see FIG. 7) capable of housing a biasing member 60 is formed in the rear side portion of the color slider 56. The biasing member 60 is, for example, a compression coil spring, is provided between the front end of the biasing housing portion 56a and the rear portion of the mounting guide 43, and biases the color slider 56 forward (in the disengagement direction D2).

The color slider 56 has first projection portions 61A to 61C which are provided so as to be contactable with the color image release arms 50A to 50C, and second projection portions 62A to 62C which are provided so as to be contactable with (the left ends of) the color image developing devices 22A to 22C. The three first projection portions 61A to 61C are arranged at substantially equal intervals in the front-and-rear direction and project leftward from the lower portion of the left side surface of the color slider 56. The three second projection portions 62A to 62C are arranged at substantially equal intervals in the front-and-rear direction and project rightward from the lower portion of the right side surface of the color slider 56. The second projection portion 62A is provided forward (in the disengagement direction D2) and is offset from the first projection portion 61A. Similarly, the second projection portions 62B and 62C are provided forward and are offset from the first projection portions 61B and 61C, respectively.

<Second Slider> As shown in FIG. 4, FIG. 7, and FIG. 12, the second slider 58 is formed into a long rod shape elongated in the front-and-rear direction and is provided on the right side (one direction in the axial direction) of the support member 41. The second slider 58 is supported by the support body 42 so as to be movable in the front-and-rear direction (the separation direction). Although the details will be described later, the second slider 58 is provided so as to be movable in the engagement direction D1 and in the disengagement direction D2 in conjunction with the first slider 54.

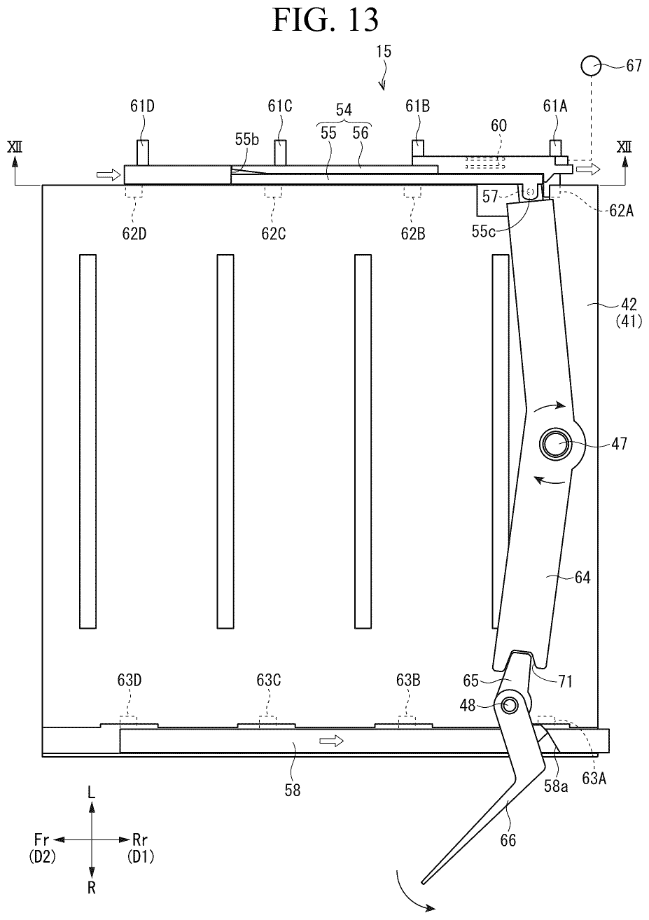

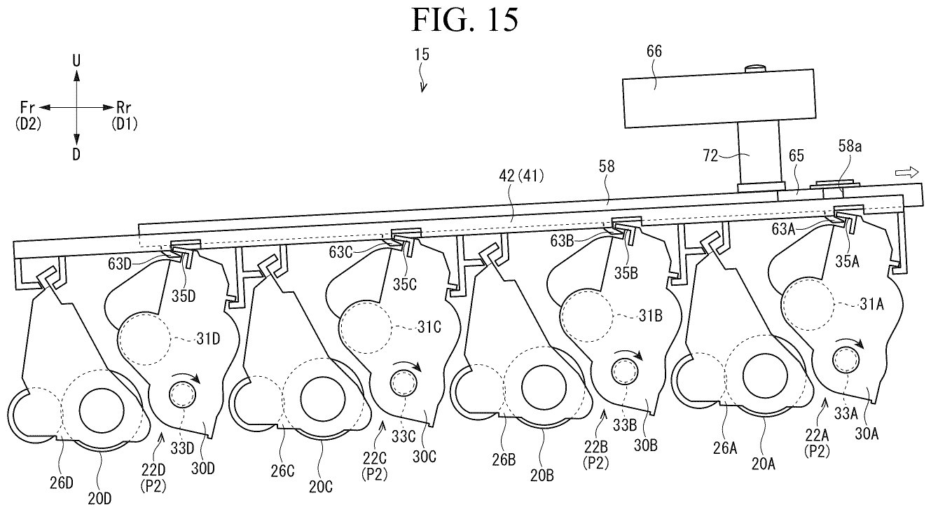

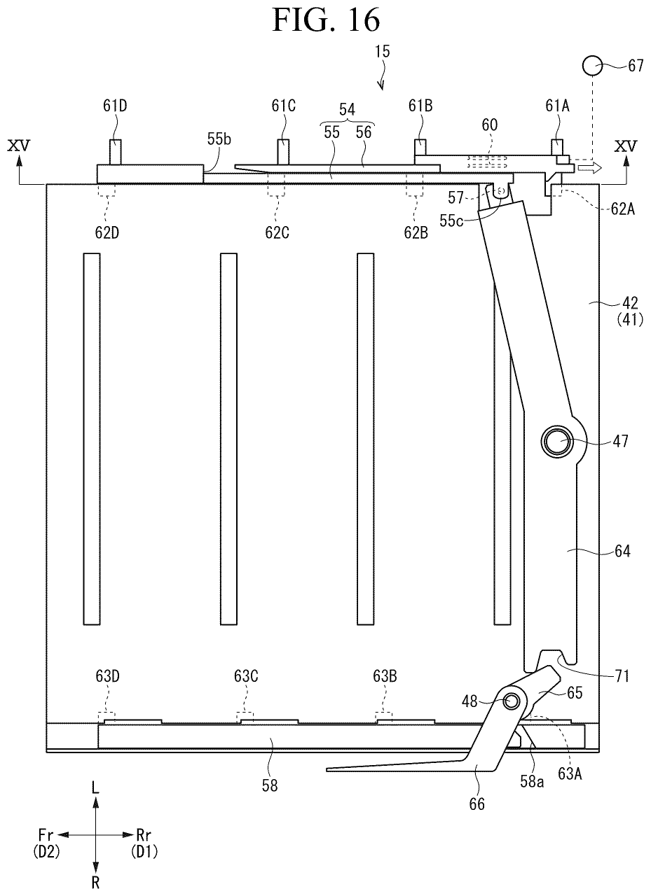

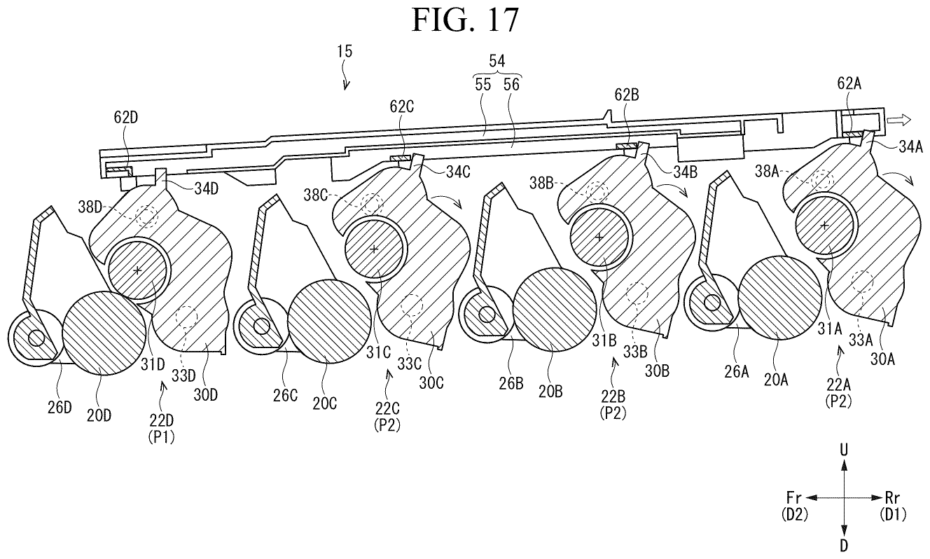

As shown in FIG. 4 and FIG. 6, the second slider 58 has third projection portions 63A to 63D which are provided so as to be contactable with the right end portions (one end portion in the axial direction) of the developing devices 22A to 22D. The four third projection portions 63A to 63D are arranged at substantially equal intervals in the front-and-rear direction and project leftward from the lower portion of the left side surface of the second slider 58. The four third projection portions 63A to 63D are arranged to face the four second projection portions 62A to 62D of the first slider 54 across the four developing devices 22A to 22D. Further, an engagement groove 58a inclined rearward from the left to the right as viewed from a plane is formed in the upper rear side portion of the second slider 58 (see FIG. 12).

<First Link> As shown in FIG. 4, FIG. 7, and FIG. 12, the first link 64 is formed in a flat plate shape bent substantially in an L-shape and is turnably supported by the support member 41. Specifically, the first link 64 is supported by a first support shaft portion 47 provided on the rear portion of the upper surface of the support body 42 at substantially the center in the left-and-right direction. The first link 64 is engaged with the first slider 54. In detail, an elongated hole 70 (see FIG. 7) is formed at the left end portion of the first link 64, and the first joint shaft portion 57 of the monochrome slider 55 is inserted into the elongated hole 70 (see FIG. 4). The first joint shaft portion 57 is supported so as to be movable along the elongated hole 70 and to be rotatable. An engagement recess 71 is formed at the right end portion of the first link 64.

<Second link> The second link 65 is formed in a flat plate shape bent substantially in an L-shape and is turnably supported by the support member 41. Specifically, the second link 65 is bent in a direction opposite to that of the first link 64 in plan view and is supported by a second support shaft portion 48 provided on the rear side of the right end portion of the upper surface of the support body 42. The right end portion of the second link 65 is engaged with the engagement groove 58a of the second slider 58. The left end portion of the second link 65 is engaged with the engagement recess 71 of the first link 64. The first link 64 and the second link 65 constitute a link mechanism 68 which interlocks the first slider 54 and the second slider 58 as shown in FIG. 4. The second link 65 has a cylindrical lever support shaft portion 72 on the same axis as the second support shaft portion 48.

<Manual Lever> The manual lever 66 is formed in a rod shape bent in a substantially L-shape and is coupled to the upper end portion of the lever support shaft portion 72 serving as a rotational shaft of the second link 65. The manual lever 66 is turned by an operator. When the operator grips the manual lever 66 and turns it around the shaft, the first link 64 and the second link 65 are turned in opposite directions to each other, thereby moving the first slider 54 and the second slider 58 in the same direction.

<Slide Driving Part> The slide drive part 67 is connected to the color slider 56 (see FIG. 4). The slide drive part 67 includes an actuator containing an eccentric cam or the like which is rotated by a solenoid or a servo motor, and a piston rod or the like which is pushed out and pulled in by the eccentric cam. As described above, the slide drive part 67 is configured to push (or pull) the color slider 56 in the engagement direction D1. In a state where the monochrome slider 55 is moved in the disengagement direction D2, the slide drive part 67 moves only the color slider 56 in the engagement direction D1. When the slide drive part 67 releases the pressing force (or tension) on the color slider 56, the monochrome slider 55 moved in the engagement direction D1 is biased by the biasing member 60 to move in the disengagement direction D2.

[Operation of Separation Device] Next, with reference to FIG. 4 to FIG. 6, FIG. 8 to FIG. 11, and FIG. 13 to FIG. 17, the operation of the separation device 15, that is, the separation operation of the developing device 22 with respect to the photosensitive drum 20 will be described. FIG. 13 is a plan view showing the separation device 15 (at an insertable/removable state). FIG. 14 is a cross-sectional view taken along the line XII-XII of FIG. 13. FIG. 15 is a right side view showing the photosensitive drum 20, the developing device 22 (at the separation position P2), and the separation device 15. FIG. 16 is a plan view showing the separation device 15 (at a monochrome printing state). FIG. 17 is a cross-sectional view taken along the line XV-XV of FIG. 16.

Here, in order to set the state of the image forming apparatus 1 to the initial state, as shown in FIG. 4 to FIG. 6, the posture of the gripping portion of the manual lever 66 is oriented along the front-and-rear direction. When the posture of the gripping portion is set in the above posture, the first slider 54 and the second slider 58 are moved in the disengagement direction D2, all the developing devices 22 are arranged at the developing position P1, and all the drive couplings 38 are coupled to all the drive transmission gears 37. In this specification, the initial state is the same as the normal printing state described later.

<Case Where Developing Device is pulled out> For example, when pulling out (removing) the photosensitive drum 20 and the developing device 22 from the apparatus main body 2 for maintenance or replacement or the like, the operator opens the cover 2A provided on the right side surface of the apparatus main body 2 to expose the right end surfaces of the photosensitive drum 20 and the developing device 22 (see FIG. 3). As shown in FIG. 13, the operator grips the manual lever 66 and pulls it toward the operator (rightward) to rotate the manual lever 66 in the counterclockwise direction in plan view. The counterclockwise direction is one direction of the two turnable directions of the manual lever 66. Then, the second link 65 turns in the counterclockwise direction around the second support shaft portion 48, and the first link 64 turns in the clockwise direction around the first support shaft portion 47. That is, as the manual lever 66 is turned, the second link 65 turns in the same direction as the manual lever 66, and the first link 64 turns in the opposite direction to the manual lever 66 in conjunction with the second link 65.

When the manual lever 66 is turned in the counterclockwise direction (one direction), the first link 64 moves the monochrome slider 55 in the engagement direction D1 (from the front to the rear) (see FIG. 14). In addition, in this case, the second link 65 moves the second slider 58 in the engagement direction D1 (see FIG. 15). Since the front end surface of the color slider is brought into contact with the abutting step portion 55b of the slider housing portion 55a, the color slider 56 moves in the engagement direction D1 (rearward) integrally with the monochrome slider 55.

When the first slider 54 (the monochrome slider 55 and the color slider 56) is moved in the engagement direction D1, the four first projection portions 61A to 61D come into contact with the arm portions 52A to 52D of the corresponding release arms 50A to 50D. Next, the first projection portions 61A to 61D in contact with the arm portions 52A to 52D push the release arms 50A to 50D having the arm portions 52A to 52D in the engagement direction D1 (rearward) (see FIG. 10). The release arms 50A to 50D are turned in the engagement direction D1 (the counterclockwise direction in FIG. 10) while bringing the arm portions 52A to 52D into contact with the inclined surface portions 46A to 46D and are moved in parallel leftward (to the separation position P4). The release arms 50A to 50D bring their left end portions into contact with the drive ribs 39A to 39D of the drive couplings 38A to 38D and push the drive couplings 38A to 38D leftward to separate them from the developing rollers 31A to 31D (the drive transmission gears 37A to 37D) (see FIG. 11). In this state, the couplings between all the developing rollers 31 and all the drive input gears 36 are released, and the drive transmission to all the developing rollers 31 is interrupted.

After all the drive couplings 38A to 38D are separated from all the drive input gears 36A to 36D (the developing rollers 31A to 31D), as shown in FIG. 14, the four second projection portions 62A to 62D come into contact with the first engagement portions 34A to 34D of the corresponding developing devices 22A to 22D. Then, the second projection portions 62A to 62D in contact with the first engagement portions 34A to 34D push the developing devices 22A to 22D having the first engagement portions 34A to 34D in the engagement direction D1. Further, as shown in FIG. 15, the four third projection portions 63A to 63D come into contact with the second engagement portions 35A to 35D of the corresponding developing devices 22A to 22D, and push the developing devices 22A to 22D in the engagement direction D1. When the first slider 54 and the second slider 58 are moved in the engagement direction D1 in the above manner, the second projection portions 62A to 62D and the third projection portions 63A to 63D push the developing device 22A to 22D in the engagement direction D1. In the above manner, the second projection portions 62A to 62D and the third projection portions 63A to 63D turn the developing devices 22A to 22D from the developing position P1 to the separation position P2 (see FIG. 14 and FIG. 15).

As described above, the state of the image forming apparatus 1 is set to the insertable/removable state where all the developing devices 22 are arranged at the separation position P2 (see FIG. 10, FIG. 11, and FIG. 13 to FIG. 15). In order to set the state of the image forming apparatus 1 to the insertable/removable state, the manual lever 66 is turned in the counterclockwise direction (one direction), and the monochrome slider 55 and the color slider 56 move in the engagement direction D1. In addition, in order to set the state of the image forming apparatus 1 to the insertable/removable state, all the first projection portions 61 push all the release arms 50, and all the second projection portions 62 and all the third projection portions 63 push all the developing devices 22. After the developing device 22 is arranged at the separation position P2 (after setting to the insertable/removable state), the operator pulls out the photosensitive drum 20 and the developing device 22 rightward. The third projection portion 63 of the second slider 58 engages with the second engagement portion 35 of the developing device 22 to guide the developing device 22 pulled out from the apparatus main body 2.

<Case Where Developing Device is attached> The operator attaches (pushes in) the developing device 22 or the like to the apparatus main body 2 in the reverse procedure of the above-described procedure of pulling out the developing device 22 or the like from the apparatus main body 2. In this case as well, the third projection portion 63 of the second slider 58 engages with the second engagement portion 35 of the developing device 22 to guide the developing device 22 being pushed into the apparatus main body 2. When the developing device 22 is arranged at the appropriate attachment position, the first engagement portion 34 of the developing device 22 engages with the second projection portion 62 of the first slider 54.

The operator grips the manual lever 66 and pushes it leftward to rotate the manual lever 66 in the clockwise direction in plan view (see FIG. 4). The clockwise direction is the other direction of the two turnable directions of the manual lever 66. Then, the second link 65 turns in the clockwise direction around the second support shaft portion 48, and the first link 64 turns in the counterclockwise direction around the first support shaft portion 47. When the manual lever 66 is turned in the clockwise direction (the other direction), the first link 64 moves the monochrome slider 55 in the disengagement direction D2 (from the rear to the front), and the second link 65 moves the second slider 58 in the disengagement direction D2. The color slider 56 is biased by the biasing member 60 and is moved in the disengagement direction D2 (forward) together with the monochrome slider 55.

When the first slider 54 (the monochrome slider 55 and the color slider 56) and the second slider 58 are moved in the disengagement direction D2, the four second projection portions 62A to 62D and the four third projection portions 63A to 63D are moved. At this time, the four second projection portions 62A to 62D and the four third projection portions 63A to 63D are moved so as to be separated from the corresponding developing devices 22A to 22D in the disengagement direction D2 (forward) (see FIG. 5 and FIG. 6). Therefore, all the developing devices 22A to 22D are biased by the return member (not shown) to turn from the separation position P2 to the developing position P1 (see FIG. 5 and FIG. 6).

After the second projection portions 62 and the third projection portions 63 are separated from the developing devices 22 in the disengagement direction D2, all the first projection portions 61A to 61D are separated from the corresponding release arms 50A to 50D in the disengagement direction D2. In the above manner, as shown in FIG. 8, all the first projection portions 61 release the pressing on the release arms 50. When the release arms 50A to 50D are turned in the disengagement direction D2 (in the clockwise direction in FIG. 8) while being in contact with the inclined surface portions 46A to 46D, the drive couplings 38A to 38D are biased rightward (to the coupling position P3) by the biasing coupling members 40A to 40D. Thus, the drive couplings 38A to 38D are coupled to the drive transmission gears 37A to 37D (see FIG. 9). As a result, the drive couplings 38A to 38D are coupled to the developing rollers 31A to 31D via the drive transmission gears 37A to 37D.

As described above, the state of the image forming apparatus 1 is set to the normal printing state where all the developing devices 22 are arranged at the developing position P1 (see FIG. 4 to FIG. 6, FIG. 8 and FIG. 9). In order to set the state of the image forming apparatus 1 to the normal printing state, the manual lever 66 is turned in the clockwise direction (the other direction), the monochrome slider 55 and the color slider 56 are moved in the disengagement direction D2. Further, in order to set the state of the image forming apparatus 1 to the normal printing state, all the second projection portions 62 and all the third projection portions 63 are separated from all the developing devices 22, and all the first projection portions 61 are separated from all the release arms 50. After the developing devices 22 are arranged at the developing position P1 (after being set to the normal printing state), the operator closes the cover 2A. Thus, the image forming apparatus 1 is set to a state where the image forming process can be performed.

<Printing Monochrome Image> For example, when the image data transmitted from an external terminal (such as a personal computer or the like) is a monochrome image (an image formed only with the black toner), the control part (not shown) of the image forming apparatus 1 drives and controls the slide drive part 67. The cover 2A of the apparatus main body 2 has been closed, and the manual lever 66 has been turned in the clockwise direction (the other direction) (the manual lever 66 is not operated).

The slide drive part 67 moves the color slider 56 in the engagement direction D1 (from the front to the rear). At this time, as shown in FIG. 16 and FIG. 17, the monochrome slider 55 is not moved and kept in a state of finishing the moving in the disengagement direction D2 (forward), and only the color slider 56 is moved in the engagement direction D1 (rearward) against the biasing force of the biasing member 60. The second slider 58 is also not moved and kept in a state of finishing the moving in the disengagement direction D2 (forward).

The three first projection portions 61A to 61C of the color slider 56 push the corresponding release arms 50A to 50C in the engagement direction D1 (rearward) (see FIG. 10 or FIG. 11). The three release arms 50A to 50C are turned in the engagement direction D1 (in the counterclockwise direction in FIG. 10) while being in contact with the inclined surface portions 46A to 46C, thereby pushing the drive couplings 38A to 38C leftward. The drive couplings 38A to 38C are separated from the developing rollers 31A to 31C (the drive transmission gears 37A to 37C), and the coupling between the developing rollers 31A to 31C and the drive input gears 36A to 36C is released. In addition, the drive transmission to the developing rollers 31A to 31C is interrupted (see FIG. 11). The drive coupling 38D is coupled to the drive transmission gear 37D, and the drive transmission of the developing roller 31D is maintained.

After the drive couplings 38A to 38C are separated from the drive input gears 36A to 36C, as shown in FIG. 17, the three second projection portions 62A to 62C of the color slider 56 come into contact with the first engagement portions 34A to 34C of the corresponding developing devices 22A to 22C. The second projection portions 62A to 62C coming into contact with the first engagement portions 34A to 34C push, in the engagement direction D1, the developing devices 22A to 22C having the first engagement portions 34A to 34C. As a result, the second projection portions 62A to 62C push the developing devices 22A to 22C in the engagement direction D1 to turn them from the developing position P1 to the separation position P2.

As described above, the state of the image forming apparatus 1 is set to the monochrome printing state where the monochrome image developing device 22D is arranged at the developing position P1 and the color image developing devices 22A to 22C are arranged at the separation position P2 (see FIG. 16 and FIG. 17). In the monochrome printing state, the turning of the manual lever 66 in the other direction is finished, and the moving of the monochrome slider 55 in the disengagement direction D2 (forward) is finished. In the monochrome printing state, the separating of the second projection portion 62D of the monochrome slider 55 from the monochrome image developing device 22D is finished, and the separating of the first projection portion 61D of the monochrome slider 55 from the release arm 50D is finished. In the monochrome printing state, the moving of the color slider 56 in the disengagement direction D2 by the slide drive part 67 is finished, and the moving of the color slider 56 in the engagement direction D1 (rearward) is finished. In the monochrome printing state, the first projection portions 61A to 61C of the color slider 56 push the release arms 50A to 50C, and the second projection portions 62A to 62C of the color slider 56 push the color image developing devices 22A to 22C. In the monochrome printing state, the separating of all the third projection portions 63 from all the developing devices 22 is finished.

The control part of the image forming apparatus 1 performs the monochrome image forming process after setting the state of the image forming apparatus 1 to the monochrome printing state. When the control part stops driving the slide drive part 67 after completion of the monochrome image forming process, the color slider 56 is biased by the biasing member 60 to move in the disengagement direction D2. Thus, the state of the image forming apparatus 1 returns to the normal printing state by the reverse procedure of the above procedure.

The above-described image forming apparatus 1 according to the present embodiment is configured such that the developing roller 31 (the developing member) is disposed rightward (one direction in the axial direction), is offset from the drive input gear 36 (the drive input member) and is coupled to the right end (one end portion in the axial direction) of the drive input gear 36. Then, the separation device 15 separates the developing roller 31 from the drive input gear 36 in the axial direction and turns the developing device 22 from the developing position P1 to the separation position P2. The separation device 15 turns the developing device 22 from the separation position P2 to the developing position P1 and then couples the developing roller 31 to the drive input gear 36 in the axial direction. According to this configuration, in the state where the developing roller 31 is separated from the drive input gear 36, the developing roller 31 comes close to or separates from the photosensitive drum 20. Therefore, the image forming apparatus 1 allows the developing device 22 to be rocked even when the developing roller 31 and the drive input gear 36 are axially aligned. Further, the separation device 15 has both the function of rocking the developing device 22 and the function of switching the drive input of the developing roller 31. Therefore, the structure of the image forming apparatus 1 can be simplified and the manufacturing cost can be reduced as compared with the case where the mechanism for rocking the developing device 22 and the mechanism for switching the drive input of the developing roller 31 are provided separately.

In the image forming apparatus 1 according to the present embodiment, the separation device 15 switches the state of the image forming apparatus 1 to any one state of the insertable/removable state, the normal printing state and the monochrome printing state. The insertable/removable state is the state where all the developing devices 22 are arranged at the separation position P2, and the normal printing state is the state where all the developing devices 22 are arranged at the developing position P1. The monochrome printing state is the state where the monochrome image developing device 22D is arranged at the developing position P1 and the color image developing devices 22A to 22C are arranged at the separation position P2. According to this configuration, by setting the state of the image forming apparatus 1 to the monochrome printing state, the image forming apparatus 1 allows the color image developing rollers 31A to 31C to be stopped in a state separated from the photosensitive drums 20A to 20C. Further, the image forming apparatus 1 allows only the monochrome image developing roller 31D to be rotated while being close to the photosensitive drum 20D. Thus, when the monochrome image is formed, the image forming apparatus 1 can suppress deterioration of the color image developing rollers 31A to 31C and the photosensitive drums 20A to 20C due to their rotation. The image forming apparatus 1 can suppress deterioration of the developer (the toner) contained in the color image developing devices 22A to 22C due to friction.

Further, in the image forming apparatus 1 according to the present embodiment, the developing roller 31 is coupled to the drive input gear 36 via the drive coupling 38, the movement of the first slider 54 in the front-and-rear direction (the separation direction) is converted into the turning of the release arm 50. Further, in the image forming apparatus 1, by turning the release arm 50 while being in contact with the inclined surface portion 46, the drive coupling 38 is moved in the left-and-right direction (the axial direction). In addition, after the drive coupling 38 is separated from the developing roller 31, the second projection portion 62 of the first slider 54 pushes the developing device 22 toward the separation position P2. Further, the second projection portion 62 of the first slider 54 is separated from the developing device 22, the developing device 22 is moved to the developing position P1, and then the drive coupling 38 is coupled to the developing roller 31. According to this configuration, the image forming apparatus 1 can interlock the rocking of the developing device 22 with the switching operation of the drive input of the developing roller 31 properly. Thus, even when the developing roller 31, the drive coupling 38, and the drive input gear 36 are disposed in the axial direction, the image forming apparatus 1 allows the developing device 22 to be rocked.

The image forming apparatus 1 according to the present embodiment allows the second projection portions 62 and the third projection portions 63 to be pressed against both the end portions of the developing devices 22 in the left-and-right direction (the axial direction) because the developing device 22 is disposed between the first slider 54 and the second slider 58. Thus, the image forming apparatus 1 can secure the stable turning of the developing devices 22. Further, since all the developing devices 22 are engaged with the third projection portions 63 of the second slider 58 in the insertable/removable state, all the developing devices 22 can be pulled out straightly while being guided by the third projection portions 63. Thus, the image forming apparatus 1 can eliminate the problem that the developing roller 31 comes into contact with the photosensitive drum 20 in the process of pulling out the developing device 22 from the apparatus main body 2.

In the image forming apparatus 1 according to the present embodiment, the first slider 54 and the second slider 58 are coupled via the link mechanism 68 including the first link 64 and the second link 65. According to this configuration, when the operator turns the manual lever 66, the first link 64 and the second link 65 are turned in opposite directions to each other, and the first link 64 and the second link 65 allow the first slider 54 and the second slider 58 to be interlocked with each other and to be moved in the same direction.

According to the above configurations, the image forming apparatus 1 includes the slide drive part 67 which moves the color slider 56 rearward, which is one direction of the separation direction, in order to set the state of the image forming apparatus 1 to the monochrome printing state. The slide drive part 67 moves the color slider 56 rearward, thereby separating the color image developing devices 22A to 22C being in contact with the second projection portions 62 of the color slider 56 rearward from the color image photosensitive drums 20A to 20C which are the image carriers.

The image forming apparatus 1 includes the link mechanism 68 which moves the monochrome slider 55 rearward, which is one direction of the separation direction, as the turning of the manual lever 66 in order to set the state of the image forming apparatus 1 to the insertable/removable state. The link mechanism 68 moves the monochrome slider 55 rearward, thereby separating the monochrome image developing device 22D being in contact with the second projection portion 62 of the monochrome slider 55 rearward from the photosensitive drum 20D. The link mechanism 68 moves the color slider 56 being in contact with the abutting step portion 55b of the monochrome slider 55 rearward, thereby separating the color image developing devices 22A to 22C rearward from the photosensitive drums 20A to 20C.

As described above, the color slider 56 which separates the developing devices 22A to 22C from the photosensitive drums 20A to 20C is a part of the mechanism (referred to as a monochrome printing state changing mechanism) which changes the state of the image forming apparatus 1 to the monochrome printing state. The color slider 56 is also a part of the mechanism which changes the state of the image forming apparatus 1 to the insertable/removable state (referred to as an insertable/removable state changing mechanism). Therefore, compared with the case where the monochrome printing state changing mechanism and the insertable/removable state changing mechanism are completely different mechanisms, the monochrome printing state changing mechanism and the insertable/removable state changing mechanism of the image forming apparatus 1 according to the present disclosure are simpler and more space-saving mechanisms. Therefore, the image forming apparatus 1 according to the present disclosure can suppress not only an increase in manufacturing cost but also an increase in size.

In the image forming apparatus 1 according to the present embodiment, the developing roller 31 is coupled to the drive input gear 36 (the drive motor) via the drive coupling 38, but the present disclosure is not limited thereto. For example, the drive coupling 38 may be omitted and the developing roller 31 may be directly coupled to the drive input gear 36 (the drive motor, not shown). In this case, the drive input gear 36 may be provided in the image forming apparatus 1 so as to be movable in the axial direction.

In the image forming apparatus 1 according to the present embodiment, the operator operates the manual lever 66 manually to slide the first slider 54 and the second slider 58 and to switch the state of the image forming apparatus 1 between the insertable/removable state and the normal printing state. However, the present disclosure is not limited thereto. For example, the image forming apparatus 1 may include a drive source (not shown) to slide the first slider 54 and the second slider 58. Alternatively, based on terminal operation by the operator, the control part may control and drive the drive source to slide the first slider 54 and the second slider 58 while being interlocked. In this case, the first link 64, the second link 65 and the manual lever 66 may be omitted.

Further, in the image forming apparatus 1 according to the present embodiment, the developing roller 31 and the drive input gear 36 are separated from or coupled to each other by the turning (rocking) of the release arm 50, but the present disclosure is not limited thereto. For example, the release arm 50 may be omitted, and a drive source (not shown) for reciprocating the drive coupling 38 (or the drive input gear 36) in the axial direction may be provided in the image forming apparatus 1. The control part may drive and control the drive source to separate or couple the developing roller 31 and the drive input gear 36.

Further, in the image forming apparatus 1 according to the present embodiment, the first slider 54 and the second slider 58 are provided so as to hold the developing device 22 from both sides in the axial direction, but the present disclosure is not limited thereto. For example, the second slider 58 may be omitted, and the first slider 54 may rock the developing device 22 (not shown).

Further, in the image forming apparatus 1 according to the present embodiment, the rocking shaft 33 of the developing device 22 is provided radially offset from the developing roller 31, but the present disclosure is not limited thereto. For example, the rocking shaft 33 may be co-axially disposed with the developing roller 31 or the drive input gear 36 (the drive transmission gear 37) (not shown). That is, the rotational shaft of the developing roller 31 or the drive input gear 36 (the drive transmission gear 37) may be the rocking shaft 33. In this case, when the developing device 22 is rocked, the developing roller 31 and the drive input gear 36 need not be separated, and the drive coupling 38 and the release arm 50 may be omitted (not shown).

Further, in the description of the above embodiment, the case is shown as an example where the present disclosure is applied to the image forming apparatus 1 (printer), but the present disclosure may be applied to, for example, a copying machine, a facsimile machine or a multifunctional peripheral or the like.

It is to be noted that the description of the above embodiment shows one mode of the image forming apparatus 1 according to the present disclosure, and the technical scope of the present disclosure is not limited to the above embodiment. The present disclosure may be variously changed, substituted, or modified without departing from the spirit of the technical idea, and the claims include all embodiments that may fall within the scope of the technical idea.

Although the disclosure has been described for specific embodiments, the disclosure is not limited to the foregoing embodiments. The above embodiments can be modified by those skilled in the art without departing from the scope and spirit of the present disclosure.

### Appended Claim 1

An image forming apparatus according to appended claim 1, comprising:
an image carrier which is attached to an apparatus main body so as to be movable in an axial direction and is configured to carry an electrostatic latent image while rotating around an axis;
a developing device which includes a developing member which is configured to rotate around an axis while being close to or in contact with the image carrier to develop the electrostatic latent image, is attached to the apparatus main body so as to be movable in the axial direction, and is configured to be turned around a rocking shaft arranged in parallel with the developing member;
a separation device which is configured to turn the developing device between a developing position where the developing member is brought close to or into contact with the image carrier and a separation position where the developing member is separated from the image carrier; and
a drive input member which is supported by the separation device so as to be rotatable around an axis, and configured to input a driving force to the developing member, wherein
the image carrier includes a plurality of image carriers including an image carrier for monochrome image and an image carrier for color image and arranged in a separation direction orthogonal to the axial direction,
the developing device includes a plurality of developing devices including a developing device for monochrome image and a developing device for color image and arranged in the separation direction,
the drive input member includes a plurality of drive input members including a drive input member for monochrome image and a drive input member for color image and arranged in the separation direction,
the image carrier and the developing device are configured to be pulled out from the apparatus main body in one direction of the axial direction in a state where the developing device is arranged at the separation position,
the developing member is disposed offset from the drive input member in the one direction in the axial direction and configured to be coupled to one end portion of the drive input member in the axial direction,
the separation device is configured to
   separate the developing member from the drive input member in the axial direction and then turn the developing device from the developing position to the separation position and
   turn the developing device from the separation position to the developing position and then couple the developing member to the drive input member in the axial direction, and
the separation device is configured to switch a state of the image forming apparatus to any one state of:
   an insertable/removable state where all of the plurality of developing devices are arranged at the separation position;
   a normal printing state where all of the plurality of developing devices are arranged at the developing position; and
   a monochrome printing state where the developing device for monochrome image is arranged at the developing position and the developing device for color image is arranged at the separation position.

### Appended Claim 2

The image forming apparatus according to appended claim 2 is an image forming apparatus according to appended claim 1, wherein
the developing member is configured to come close to or into contact with the image carrier from one direction of the separation direction and be coupled to the one end portion of the drive input member in the axial direction via a cylindrical drive coupling,
the separation device includes:
a support member which supports the drive coupling so as to be rotatable and movable in the axial direction;
a plurality of release arms which are provided so as to be turnable around an outer peripheral surface of the drive coupling, and are configured to be turned while coming into contact with an inclined surface portion formed on the support member to be moved in the axial direction; and
a first slider which is provided so as to be movable in an engagement direction, which is the one direction of the separation direction and in a disengagement direction, which is the other direction of the separation direction,
the first slider includes a monochrome slider corresponding to the developing device for monochrome image and a color slider corresponding to the developing device for color image,
each of the monochrome slider and the color slider has a first projection portion provided to be contactable with the plurality of release arms and a second projection portion provided to be contactable with the developing device,
the first slider and the plurality of release arms are configured such that when the first slider is moved in the engagement direction, the first projection portion pushes the plurality of release arms in the engagement direction, the plurality of release arms is turned in the engagement direction while being in contact with the inclined surface portion, thereby separating the drive coupling from the developing member, and then the second projection portion pushes the developing device in the engagement direction to turn the developing device from the developing position to the separation position,
the first slider, the developing device and the plurality of release arms are configured such that when the first slider is moved in the disengagement direction, the second projection portion is separated from the developing device in the disengagement direction, the developing device is turned from the separation position to the developing position, then the first projection portion is separated from the plurality of release arms in the disengagement direction, and the plurality of release arms is turned in the disengagement direction while being in contact with the inclined surface portion, thereby coupling the drive coupling to the developing member,
the monochrome slider and the color slider are configured such that in order to set the state of the image forming apparatus to the insertable/removable state, the monochrome slider and the color slider are moved in the engagement direction, both first projection portions of the first projection portion of the monochrome slider and the first projection portion of the color slider push all of the plurality of release arms, and both second projection portions of the second projection portion of the monochrome slider and the second projection portion of the color slider push all of the plurality of developing devices,
the monochrome slider and the color slider are configured such that in order to set the state of the image forming apparatus to the normal printing state, the monochrome slider and the color slider are moved in the disengagement direction, the both second projection portions are separated from all of the plurality of developing devices, and the both first projection portions are separated from all of the plurality of release arms, and
the monochrome slider and the color slider are configured such that in order to set the state of the image forming apparatus to the monochrome printing state, the monochrome slider is moved in the disengagement direction, the second projection portion of the monochrome slider is separated from the developing device for monochrome image, the first projection portion of the monochrome slider is separated from a release arm for monochrome image of the plurality of release arms, the color slider is moved in the engagement direction, the first projection portion of the color slider pushes a release arm for color image of the plurality of release arms, and the second projection portion of the color slider pushes the developing device for color image.

### Appended Claim 3

The image forming apparatus according to appended claim 3 is an image forming apparatus according to appended claim 1 or 2, wherein
the separation device further includes a second slider which is provided so as to be movable in the engagement direction and in the disengagement direction in conjunction with the first slider,
the first slider and the plurality of release arms are provided on the other side of the support member in the axial direction,
the both second projection portions are configured to be in contact with the other end portion of the developing device in the axial direction,
the second slider is provided on the one side of the support member in the axial direction and has third projection portions which are provided so as to be contactable with one end portion of the developing device in the axial direction,
the first slider, the second slider and the drive coupling are configured such that when the first slider and the second slider are moved in the engagement direction, the drive coupling is separated from the developing member, then the both second projection portions and the third projection portions push the developing device in the engagement direction, thereby turning the developing device from the developing position to the separation position,
the first slider, the second slider and the drive coupling are configured such that when the first slider and the second slider are moved in the disengagement direction, the both second projection portions and the third projection portions are separated from the developing device in the disengagement direction, and then the drive coupling is coupled to the developing member,
all the third projection portions are configured to, in the insertable/removable state, push all of the plurality of developing devices and guide the developing device to be pulled out from the apparatus main body, and
all the third projection portions are configured to, in the normal printing state and the monochrome printing state, be separated from all of the plurality of developing devices.

### Appended Claim 4

The image forming apparatus according to appended claim 4 is an image forming apparatus according to any one of appended claims 1 to 3, wherein
the separation device includes:
a first link rotatably supported by the support member and engaged with the monochrome slider;
a second link rotatably supported by the support member and engaged with the first link and the second slider;
a manual lever coupled to a rotational shaft of the second link;
a slide drive part configured to move the color slider toward the engagement direction; and
a biasing member configured to bias the color slider toward the disengagement direction, wherein
the first link and the second link are configured such that as the manual lever is turned, the second link turns in the same direction as a turning direction in which the manual lever is turned, and the first link turns in an opposite direction to the turning direction of the manual lever in conjunction with the second link,
the manual lever is turnable in two directions,
the first link and the second link are configured such that when the manual lever is turned in one direction of the two directions, the first link moves the monochrome slider in the engagement direction together with the color slider, and the second link moves the second slider in the engagement direction,
the first link, the biasing member and the second link are configured such that when the manual lever is turned in the other direction of the two directions, the first link moves the monochrome slider in the disengagement direction, the biasing member moves the color slider in the disengagement direction, and the second link moves the second slider in the disengagement direction,
the manual lever is configured to, in order to set the state of the image forming apparatus to the insertable/removable state, be turned in the one direction,
the manual lever is configured to, in order to set the state of the image forming apparatus to the normal printing state, be turned in the other direction, and
the manual lever, the slide drive part and the color slider are configured such that in order to set the state of the image forming apparatus to the monochrome printing state, the manual lever is turned in the other direction, the slide drive part moves the color slider in the disengagement direction, the first projection portion of the color slider pushes the release arm for color image, and the second projection portion of the color slider pushes the developing device for color image.

### Appended Claim 5

The image forming apparatus according to appended claim 5 is an image forming apparatus according to any one of appended claims 1 to 4, wherein
the slide drive part is configured to move the color slider in the one direction of the separation direction in order to set the state of the image forming apparatus to the monochrome printing state, thereby
causing the second projection portion of the color slider to come into contact with the developing device for color image, and
causing the second projection portion of the color slider to move the developing device for color image in the one direction of the separation direction and to separate the developing device for color image from the image carrier for color image.

### Appended Claim 6

The image forming apparatus according to appended claim 6 is an image forming apparatus according to any one of appended claims 1 to 5, wherein
the monochrome slider further includes an abutting step portion configured to abut on the color slider, and
the second link is configured to move the monochrome slider in the one direction of the separation direction as the manual lever is turned, in order to set the state of the image forming apparatus to the insertable/removable state, thereby
causing the second projection portion of the monochrome slider to come into contact with the developing device for monochrome image to separate the developing device for monochrome image from the image carrier for monochrome image in the one direction of the separation direction, and
causing the abutting step portion of the monochrome slider to abut on the color slider and to move the color slider in the one direction of the separation direction, thereby separating the developing device for color image from the image carrier for color image.

### Appended Claim 7

The image forming apparatus according to appended claim 7, comprising:
a developing device for monochrome image configured to come close to or come into contact with an image carrier for monochrome image in one direction of a predetermined separation direction and develop an electrostatic latent image carried by the image carrier for monochrome image;
a developing device for color image configured to come close to or come into contact with an image carrier for color image in the one direction of the separation direction and develop an electrostatic latent image carried by the image carrier for color image;
a color slider having a projection portion configured to come into contact with the developing device for color image;
a slide drive part configured to move the color slider in the one direction of the separation direction in order to set a state of the image forming apparatus to a monochrome printing state, thereby
   causing the projection portion of the color slider to come into contact with the developing device for color image, and
   causing the projection portion of the color slider to move the developing device for color image in the one direction of the separation direction and to separate the developing device for color image from the image carrier for color image,
   the monochrome printing state being a state where the developing device for monochrome image is closer to or in contact with the image carrier for monochrome image and the developing device for color image is separated from the image carrier for color image;
a monochrome slider having an abutting step portion configured to abut on the color slider and a projection portion configured to come into contact with the developing device for monochrome image; and
a link mechanism engaged with the monochrome slider and coupled to a manual lever and configured to move the monochrome slider in the one direction of the separation direction as the manual lever is turned, in order to set the state of the image forming apparatus to an insertable/removable state, thereby
causing the projection portion of the monochrome slider to come into contact with the developing device for monochrome image and to separate the developing device for monochrome image from the image carrier for monochrome image in the one direction of the separation direction, and
causing the abutting step portion of the monochrome slider to abut on the color slider and to move the color slider in the one direction of the separation direction, thereby separating the developing device for color image from the image carrier for color image,
the insertable/removable state being a state where the developing device for monochrome image is separated from the image carrier for monochrome image and the developing device for color image is separated from the image carrier for color image.

### Appended Claim 8

The image forming apparatus according to appended claim 8 is an image forming apparatus according to appended claim 7, wherein
the slide drive part is configured to move the color slider in the one direction of the separation direction in order to set the state of the image forming apparatus from a normal printing state to the monochrome printing state,
the link mechanism is configured to move the monochrome slider in the one direction of the separation direction in order to set the state of the image forming apparatus from the normal printing state to the insertable/removable state, and
the normal printing state is a state where the developing device for monochrome image is closer to or in contact with the image carrier for monochrome image, and the developing device for color image is closer to or in contact with the image carrier for color image.

1. An image forming apparatus comprising:
an image carrier which is attached to an apparatus main body so as to be movable in an axial direction and is configured to carry an electrostatic latent image while rotating around an axis;
a developing device which includes a developing member which is configured to rotate around an axis while being close to or in contact with the image carrier to develop the electrostatic latent image, is attached to the apparatus main body so as to be movable in the axial direction, and is configured to be turned around a rocking shaft arranged in parallel with the developing member;
a separation device which is configured to turn the developing device between a developing position where the developing member is brought close to or into contact with the image carrier and a separation position where the developing member is separated from the image carrier; and
a drive input member which is supported by the separation device so as to be rotatable around an axis, and configured to input a driving force to the developing member, wherein
the image carrier includes a plurality of image carriers including an image carrier for monochrome image and an image carrier for color image and arranged in a separation direction orthogonal to the axial direction,
the developing device includes a plurality of developing devices including a developing device for monochrome image and a developing device for color image and arranged in the separation direction,
the drive input member includes a plurality of drive input members including a drive input member for monochrome image and a drive input member for color image and arranged in the separation direction,
the image carrier and the developing device are configured to be pulled out from the apparatus main body in one direction of the axial direction in a state where the developing device is arranged at the separation position,
the developing member is disposed offset from the drive input member in the one direction in the axial direction and configured to be coupled to one end portion of the drive input member in the axial direction,
the separation device is configured to
separate the developing member from the drive input member in the axial direction and then turn the developing device from the developing position to the separation position and
turn the developing device from the separation position to the developing position and then couple the developing member to the drive input member in the axial direction, and
the separation device is configured to switch a state of the image forming apparatus to any one state of:
an insertable/removable state where all of the plurality of developing devices are arranged at the separation position;
a normal printing state where all of the plurality of developing devices are arranged at the developing position; and
a monochrome printing state where the developing device for monochrome image is arranged at the developing position and the developing device for color image is arranged at the separation position.

2. The image forming apparatus according to claim 1, wherein
the developing member is configured to come close to or into contact with the image carrier from one direction of the separation direction and be coupled to the one end portion of the drive input member in the axial direction via a cylindrical drive coupling,
the separation device includes:
a support member which supports the drive coupling so as to be rotatable and movable in the axial direction;
a plurality of release arms which are provided so as to be turnable around an outer peripheral surface of the drive coupling, and are configured to be turned while coming into contact with an inclined surface portion formed on the support member to be moved in the axial direction; and
a first slider which is provided so as to be movable in an engagement direction, which is the one direction of the separation direction and in a disengagement direction, which is the other direction of the separation direction,
the first slider includes a monochrome slider corresponding to the developing device for monochrome image and a color slider corresponding to the developing device for color image,
each of the monochrome slider and the color slider has a first projection portion provided to be contactable with the plurality of release arms and a second projection portion provided to be contactable with the developing device,
the first slider and the plurality of release arms are configured such that when the first slider is moved in the engagement direction, the first projection portion pushes the plurality of release arms in the engagement direction, the plurality of release arms is turned in the engagement direction while being in contact with the inclined surface portion, thereby separating the drive coupling from the developing member, and then the second projection portion pushes the developing device in the engagement direction to turn the developing device from the developing position to the separation position,
the first slider, the developing device and the plurality of release arms are configured such that when the first slider is moved in the disengagement direction, the second projection portion is separated from the developing device in the disengagement direction, the developing device is turned from the separation position to the developing position, then the first projection portion is separated from the plurality of release arms in the disengagement direction, and the plurality of release arms is turned in the disengagement direction while being in contact with the inclined surface portion, thereby coupling the drive coupling to the developing member,
the monochrome slider and the color slider are configured such that in order to set the state of the image forming apparatus to the insertable/removable state, the monochrome slider and the color slider are moved in the engagement direction, both first projection portions of the first projection portion of the monochrome slider and the first projection portion of the color slider push all of the plurality of release arms, and both second projection portions of the second projection portion of the monochrome slider and the second projection portion of the color slider push all of the plurality of developing devices,
the monochrome slider and the color slider are configured such that in order to set the state of the image forming apparatus to the normal printing state, the monochrome slider and the color slider are moved in the disengagement direction, the both second projection portions are separated from all of the plurality of developing devices, and the both first projection portions are separated from all of the plurality of release arms, and
the monochrome slider and the color slider are configured such that in order to set the state of the image forming apparatus to the monochrome printing state, the monochrome slider is moved in the disengagement direction, the second projection portion of the monochrome slider is separated from the developing device for monochrome image, the first projection portion of the monochrome slider is separated from a release arm for monochrome image of the plurality of release arms, the color slider is moved in the engagement direction, the first projection portion of the color slider pushes a release arm for color image of the plurality of release arms, and the second projection portion of the color slider pushes the developing device for color image.

3. The image forming apparatus according to claim 2, wherein
the separation device further includes a second slider which is provided so as to be movable in the engagement direction and in the disengagement direction in conjunction with the first slider,
the first slider and the plurality of release arms are provided on the other side of the support member in the axial direction,
the both second projection portions are configured to be in contact with the other end portion of the developing device in the axial direction,
the second slider is provided on the one side of the support member in the axial direction and has third projection portions which are provided so as to be contactable with one end portion of the developing device in the axial direction,
the first slider, the second slider and the drive coupling are configured such that when the first slider and the second slider are moved in the engagement direction, the drive coupling is separated from the developing member, then the both second projection portions and the third projection portions push the developing device in the engagement direction, thereby turning the developing device from the developing position to the separation position,
the first slider, the second slider and the drive coupling are configured such that when the first slider and the second slider are moved in the disengagement direction, the both second projection portions and the third projection portions are separated from the developing device in the disengagement direction, and then the drive coupling is coupled to the developing member,
all the third projection portions are configured to, in the insertable/removable state, push all of the plurality of developing devices and guide the developing device to be pulled out from the apparatus main body, and
all the third projection portions are configured to, in the normal printing state and the monochrome printing state, be separated from all of the plurality of developing devices.

4. The image forming apparatus according to claim 3, wherein
the separation device includes:
a first link rotatably supported by the support member and engaged with the monochrome slider;
a second link rotatably supported by the support member and engaged with the first link and the second slider;
a manual lever coupled to a rotational shaft of the second link;
a slide drive part configured to move the color slider toward the engagement direction; and
a biasing member configured to bias the color slider toward the disengagement direction, wherein
the first link and the second link are configured such that as the manual lever is turned, the second link turns in the same direction as a turning direction in which the manual lever is turned, and the first link turns in an opposite direction to the turning direction of the manual lever in conjunction with the second link,
the manual lever is turnable in two directions,
the first link and the second link are configured such that when the manual lever is turned in one direction of the two directions, the first link moves the monochrome slider in the engagement direction together with the color slider, and the second link moves the second slider in the engagement direction,
the first link, the biasing member and the second link are configured such that when the manual lever is turned in the other direction of the two directions, the first link moves the monochrome slider in the disengagement direction, the biasing member moves the color slider in the disengagement direction, and the second link moves the second slider in the disengagement direction,
the manual lever is configured to, in order to set the state of the image forming apparatus to the insertable/removable state, be turned in the one direction,
the manual lever is configured to, in order to set the state of the image forming apparatus to the normal printing state, be turned in the other direction, and
the manual lever, the slide drive part and the color slider are configured such that in order to set the state of the image forming apparatus to the monochrome printing state, the manual lever is turned in the other direction, the slide drive part moves the color slider in the disengagement direction, the first projection portion of the color slider pushes the release arm for color image, and the second projection portion of the color slider pushes the developing device for color image.

5. The image forming apparatus according to claim 4, wherein
the slide drive part is configured to move the color slider in the one direction of the separation direction in order to set the state of the image forming apparatus to the monochrome printing state, thereby
causing the second projection portion of the color slider to come into contact with the developing device for color image, and
causing the second projection portion of the color slider to move the developing device for color image in the one direction of the separation direction and to separate the developing device for color image from the image carrier for color image.

6. The image forming apparatus according to claim 5, wherein
the monochrome slider further includes an abutting step portion configured to abut on the color slider, and
the second link is configured to move the monochrome slider in the one direction of the separation direction as the manual lever is turned, in order to set the state of the image forming apparatus to the insertable/removable state, thereby
causing the second projection portion of the monochrome slider to come into contact with the developing device for monochrome image to separate the developing device for monochrome image from the image carrier for monochrome image in the one direction of the separation direction, and
causing the abutting step portion of the monochrome slider to abut on the color slider and to move the color slider in the one direction of the separation direction, thereby separating the developing device for color image from the image carrier for color image.

7. An image forming apparatus comprising:
a developing device for monochrome image configured to come close to or come into contact with an image carrier for monochrome image in one direction of a predetermined separation direction and develop an electrostatic latent image carried by the image carrier for monochrome image;
a developing device for color image configured to come close to or come into contact with an image carrier for color image in the one direction of the separation direction and develop an electrostatic latent image carried by the image carrier for color image;
a color slider having a projection portion configured to come into contact with the developing device for color image;
a slide drive part configured to move the color slider in the one direction of the separation direction in order to set a state of the image forming apparatus to a monochrome printing state, thereby
causing the projection portion of the color slider to come into contact with the developing device for color image, and
causing the projection portion of the color slider to move the developing device for color image in the one direction of the separation direction and to separate the developing device for color image from the image carrier for color image,
the monochrome printing state being a state where the developing device for monochrome image is closer to or in contact with the image carrier for monochrome image and the developing device for color image is separated from the image carrier for color image;
a monochrome slider having an abutting step portion configured to abut on the color slider and a projection portion configured to come into contact with the developing device for monochrome image; and
a link mechanism engaged with the monochrome slider and coupled to a manual lever and configured to move the monochrome slider in the one direction of the separation direction as the manual lever is turned, in order to set the state of the image forming apparatus to an insertable/removable state, thereby
causing the projection portion of the monochrome slider to come into contact with the developing device for monochrome image and to separate the developing device for monochrome image from the image carrier for monochrome image in the one direction of the separation direction, and
causing the abutting step portion of the monochrome slider to abut on the color slider and to move the color slider in the one direction of the separation direction, thereby separating the developing device for color image from the image carrier for color image,
the insertable/removable state being a state where the developing device for monochrome image is separated from the image carrier for monochrome image and the developing device for color image is separated from the image carrier for color image.

8. The image forming apparatus according to claim 7, wherein
the slide drive part is configured to move the color slider in the one direction of the separation direction in order to set the state of the image forming apparatus from a normal printing state to the monochrome printing state,
the link mechanism is configured to move the monochrome slider in the one direction of the separation direction in order to set the state of the image forming apparatus from the normal printing state to the insertable/removable state, and
the normal printing state is a state where the developing device for monochrome image is closer to or in contact with the image carrier for monochrome image, and the developing device for color image is closer to or in contact with the image carrier for color image.
